(19) United States
(12) Patent Application Publication
(10) Pub. No.: US 2003/0097351 A1
(43) Pub. Date: May 22, 2003

(54) Portable personal medical image storage device

(76) Inventors: Peter A. Rothschild, Redwood City, CA (US); Vijendra Guru Raaj Prasad, Redwood City, CA (US)

Correspondence Address: PETERS, VERNY, JONES & BIKSA LLP, Suite 6, 385 Sherman Avenue, Palo Alto, CA, 94306, US

(21) Appl. No.: 09/993,219

(22) Filed: Nov. 20, 2001

(51) Int. Cl. G06F 7/00

(52) U.S. Cl. 707/1

(57) ABSTRACT

A portable device is provided to be carried e.g. by an individual or a family member, that contains medical history and medical image files including, among other things, medical data, images, reports, and other patient information. The device is small and in one embodiment comprises a key chain or thumb-sized device. The device includes an installer with viewing software that can be installed though a universal port on to any viewing device such as a PC. The viewing software also allows addition and removal of data files to and from the portable device, and incorporation of the data files into a relational database on the portable device.

### BACKGROUND

A predominant number of patients who desire to obtain copies of medical images or other medical records relating to medical or healthcare issues from sometime in their past are often frustrated with the inability to find their records. Images from imaging centers or hospitals may be discarded after required document retention periods have expired. Patients may lose contact with the imaging center, or lose information identifying the images or studies completed, etc. Furthermore, a patient's medical history are typically scattered throughout a number of different locations, some of which may have changed ownership, etc. When medical images are obtainable, typically getting copies entails having expensive copies made of imaging films, which are cumbersome and require time to make. A patient may need past medical history, images and reports on an emergency basis and will not under the scenario described above, be able to obtain the information in a timely manner. Accordingly, it would be desirable to provide a medical image storage device that contains the lifetime medical history including images, reports and tests, of a patient. It would also be desirable to provide a patient with the ability to maintain and access such medical records at any time. It would also be desirable to provide a patient with the ability to easily carry the information with them so that the information would always be available, for example when the patient travels or relocates. Furthermore, it would be desirable to provide information that can be universally accessible without the requirement of special equipment.

Medical images have been stored on CD-ROM's with viewing software included in the CD-ROM. However, it is believed that these CD-ROMs are not provided with the ability to add, annotate or organize files, i.e., they do not provide a system that will enable lifetime storage of medical information. Furthermore, a CD-Rom is not convenient for a user to carry with them consistently wherever the user goes.

Some proposals have been made to keep medical records on card devices requiring special card readers. It is believed that these systems would require special readers not universally available and do not include means necessary to organize or display and manipulate the information on the card itself.

Accordingly it would be desirable to provide a portable device medical information storage device for storing images and records that can be viewed, updated and augmented by a patient or healthcare provider, that does not require a provider/user or the patient have a separate special viewing software or special devices to read or manipulate data.

### SUMMARY OF THE INVENTION

The present invention provides a portable device to be carried e.g. by an individual or a family member, that contains medical history and medical image files including, among other things, data, images, reports, and other patient information. The device is small and in one embodiment comprises a key chain or pen-sized device. The portable device contains an installer for installing a viewing program into a viewing station with a universal port or interface. The viewing program is a means or mechanism to view and manipulate the images, data and software, i.e. a viewer. The viewer is typically a software-based device that enables such image viewing and manipulation. The installed viewing program also enables a health care provider with a computer where appropriate, to update the medical files. The portable device is carried by an individual and may carry medical images acquired throughout the patient's lifetime. The patient may also update and/or backup the files using a computer with a universal port or interface.

A further aspect of a viewer of invention provides a relational database that permits locating and identifying medical images and files stored in the portable device. The viewer itself may include organizational features that allow selection, viewing and manipulation of data and addition of information, or related images and reports to the memory. The viewer software stores information according to an organizational structure that permits the viewer to locate data files based on predetermined parameters. The viewer then converts the data to a readable displayable format. The viewer further permits manipulation of the image. The notations or markings are made on the image and stored as an associated image file on the portable device. The viewer enables viewing of the images that have been protected from unauthorized use.

The memory of the storage device is dynamic permitting adding or removing files by authorized users. The portable device may be any available storage or memory device that is very small, connects with a universal port, has sufficient memory to store image and other files, and can be erased and rewritten over. Such a device that is currently available includes flash memory devices, such as a pen-sized device or thumb-sized device with a USB port connector. Files may also be added from the patient's computer, e.g., images, test results, or other data files may be sent to a patient via e-mail and downloaded to the device; images taken with a digital camera may be stored on the device as well.

In use, a user desiring to access medical images will insert the storage device into the universal port interface on a computer that has software recognizing a removable drive at the port when the device is inserted. If the computer does not already have the viewer installed, it is installed from the portable storage device.

Through the viewer, the user will import the data set for a particular patient into the computer or display device. The user selected the data to be imported through the viewer, which accesses the data on the device through the relational database.

If desired, data may be optionally protected from unauthorized users through a password or biometric data that may be stored by the user/patient onto the device. Thus, access to the data of the device may be allowed upon entry of an appropriate password or by a reader, for example, associated with the display device or computer that reads biometric data from the patient.

### DESCRIPTION OF DRAWINGS

FIG. 1 illustrates a perspective view of the storage device of the invention.

FIG. 2 illustrates an exploded perspective view of a storage device of the present invention in use with a display device/processor/viewing station.

FIG. 3 illustrates a schematic of the storage device of FIG. 1.

FIG. 4 illustrates a schematic of the relational database of FIG. 3.

FIG. 5 is a schematic of the steps of incorporating data into the storage device of the invention.

### DETAILED DESCRIPTION

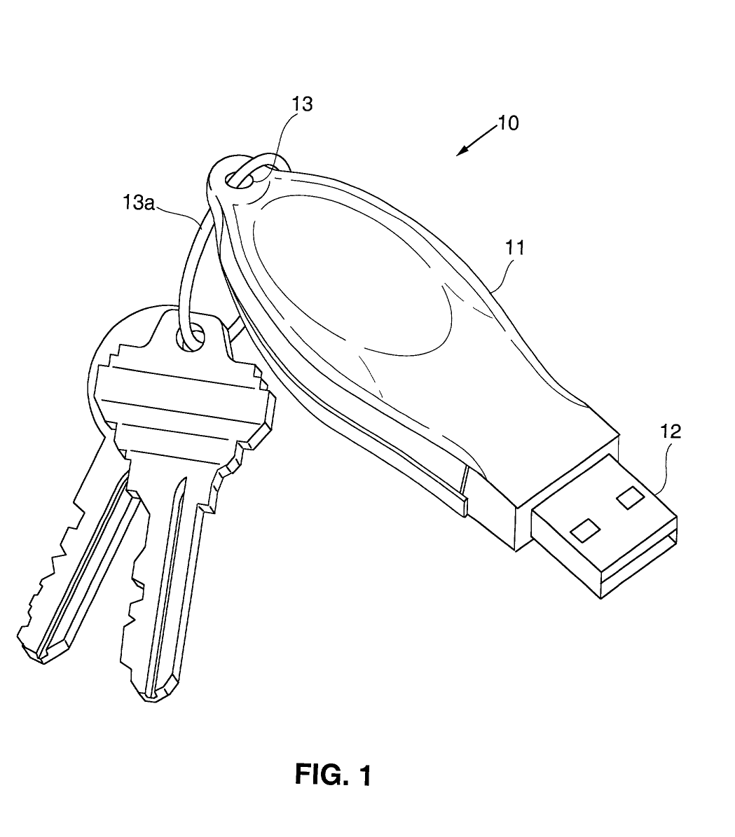

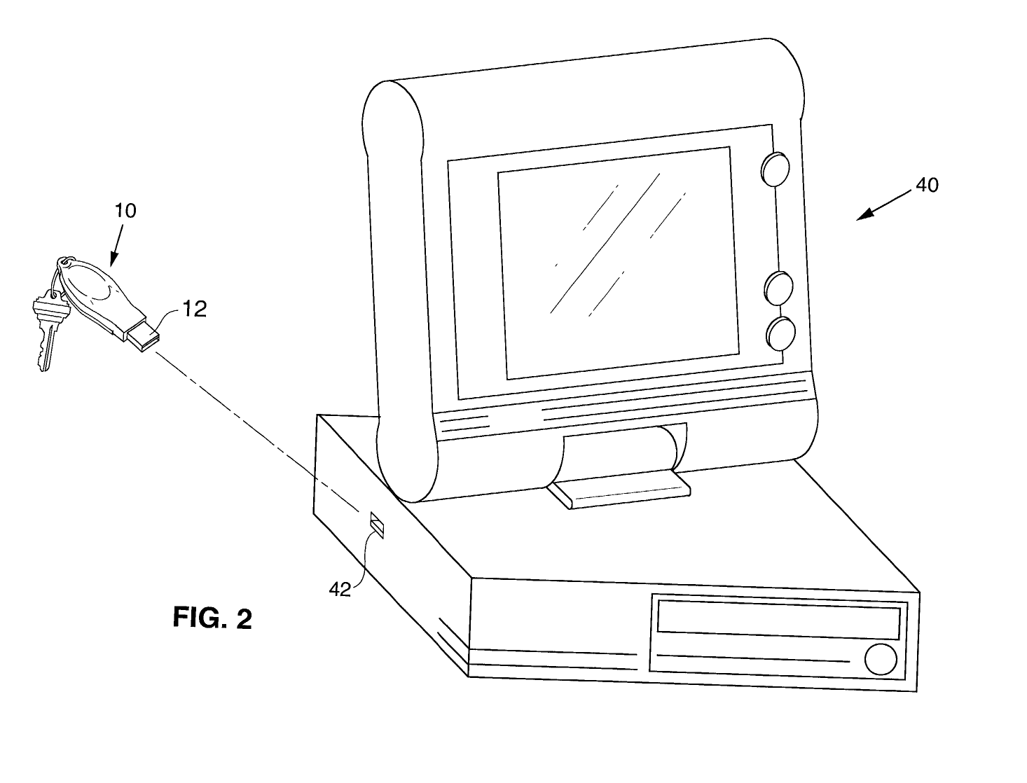

Referring now to FIGS. 1-2 there is illustrated a storage device 10 of an embodiment of the present invention. The storage device 10 comprises a housing 11; a universal interface/connector 12 on the housing 11 and configured to connect the storage device 10 to a universal port such as a USB port; a key ring 13; and an internal memory device 14 contained by the housing 11 and operatively coupled to the interface/connector 12. The housing 11 is of a size and shape that can be comfortably held in a user's hand. The housing 11 includes an opening 13a for receiving the key ring 13 to carry keys, identification tags, or the like. The memory device 14 is a readable rewritable dynamic memory device that is capable of being contained in a small, key chain, thumb sized, or pen-sized device. The memory device 14 comprises a security device 15 enabling access to the data files by password, biometric or other security mechanisms. The memory device 14 further comprises an installer 16 with viewer software 17; data files 18 including image files 19 and other associated patient related files; and a relational database 20.

Referring now to FIG. 2, the storage device 10 is illustrated with a viewing station 40, i.e., a display device, computer/processor or other device that is capable of reading, the data files 18 with viewer software 17, and capable of displaying the files 18, in a viewable format on a display screen 41 and/or through an audible display. The viewing station 40 includes a USB port 42 configured to receive the USB connector 12 of the storage device 10. The viewing station 40 either has the viewing software 17 preloaded into its memory, or has software that will recognize the storage device plugged into the USB port 42 as a removable drive, so that the viewing software 17 can be installed from the storage device 10. Currently, software capable of recognizing a drive at a USB port includes, for example, Windows 2000™, Windows XP™ and Mac OS™ version 8.6 and above. The installer 16 includes installation software for installing the viewing software 17 into the viewing station 40. When the storage device 10 is plugged into the USB port 42, the viewing software 17 is downloaded into the viewing station 40 using the installation software. Data files 18 may be requested with the viewing software 17, which is able to access the relational database 20 in the memory 14 of the storage device 10. The data files 18 include medical image files 19, and other files such as, e.g., patient data, medical history files and information, reports, health care provider information, test results, vital sign readings, patient self-monitored information or data, downloaded electrically monitored information such as, e.g., an EKG, or other information that may relate to the patient's health or healthcare history. The data files 18 may be any type of file that can be digitally stored including image files, text files, sound files, or other data files. The data files 18 may include files and data acquired throughout the patient's lifetime. The data files may also contain health related files of other individuals, for example, dependents or other family members.

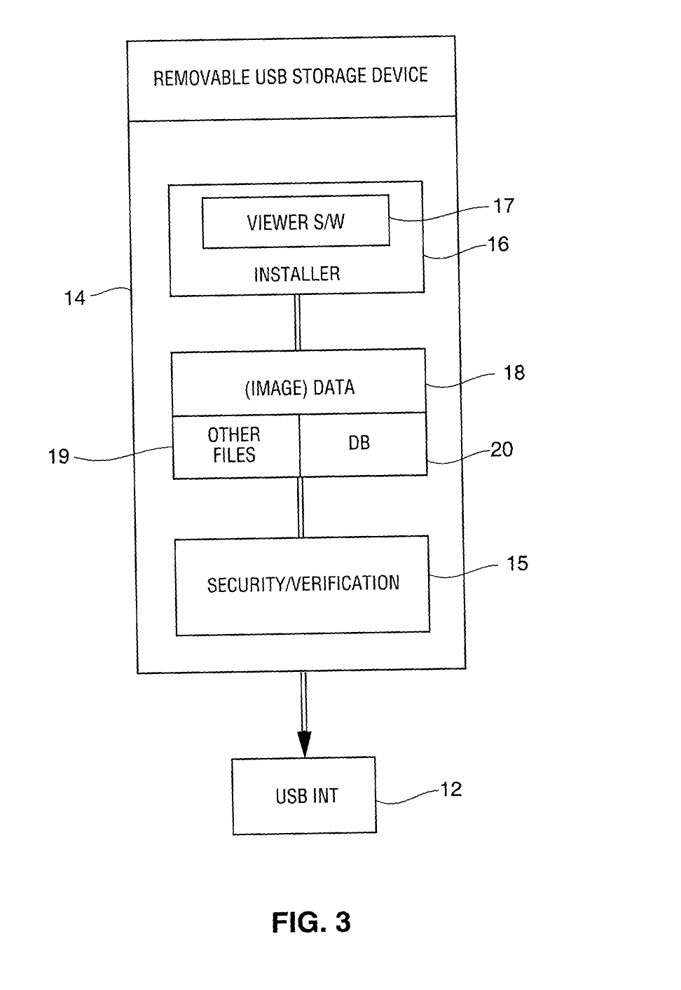

Referring now to FIG. 3 a schematic of the internal memory device 14 is illustrated. The internal memory device 14 is coupled to a universal connector 12 such as, for example a USB connector that may be used with any standard PC. An example of a memory storage device that may be used in the present invention may be, the Trek Thumbdrive® which is a thumb-sized flash memory device or the Pen Drive® which is a USB interface non-volatile disk, driver free flash memory storage device. The internal memory device 14 includes a security device that stores and recognizes identification means such as passwords and/or biometrics. Access to data files 18 is controlled by the security device, which verifies appropriate user identification. The internal memory device 14 of the invention includes an installer 16 with viewer software 17. The installer 16 is adapted to load the viewer software 17 on to the viewing station 40 to which it is coupled through a USB port 42 by the universal interface/connector 12. The viewer software 17 includes software that enables the reading and manipulation of the data files including the visual or audio display of the data files 18. An example of viewing software that may be used in the present invention is in use with the RadVault™ Viewer. The viewing software 17 may include features that enable the manipulation of the image files for viewing including the ability to input overlays and attachments such as reports or comments, which may be saved according to the structure of the relational database 20. The viewer software 17 also provides software that enables the saving of new files to the memory device through the universal port connector 12 to add to the patient's data files.

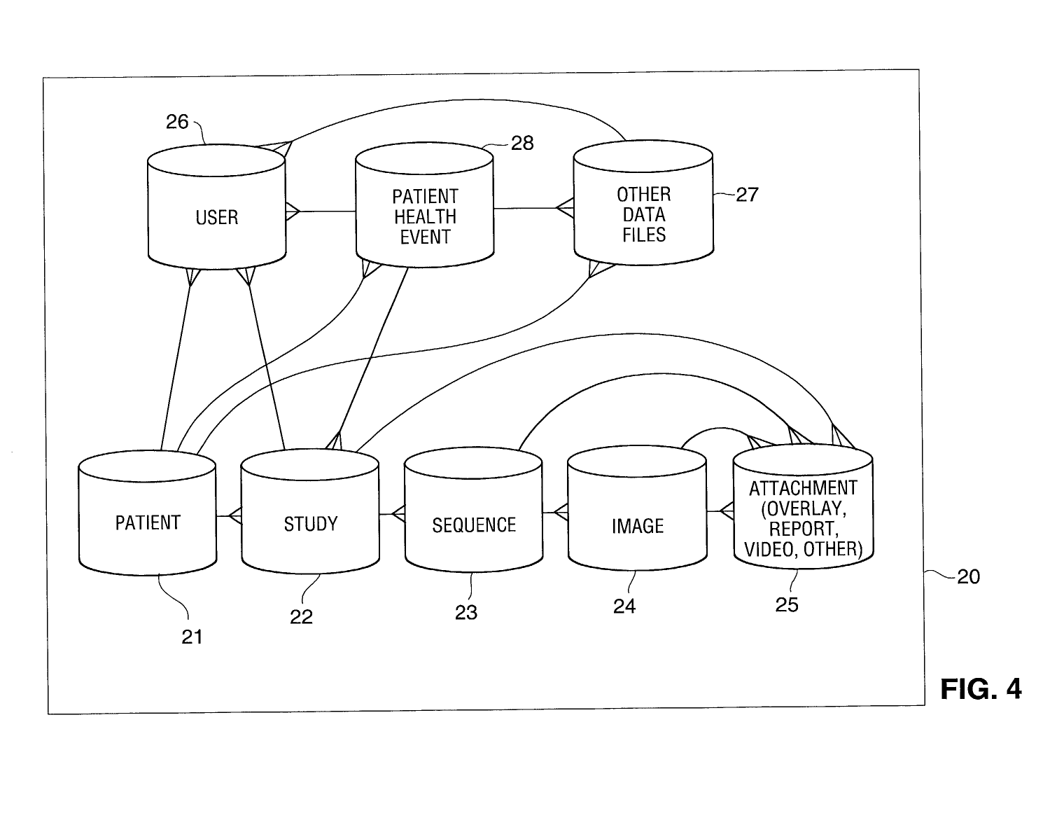

The relational database 20 illustrated in FIG. 4 shows the primary elements of the relational database 20 to be provided with the viewer software 17 and data files 18. The relational database 20 may be implemented, for example, using one of a number of database systems, for example an Oracle™ database, Access™ or other relational database. Lines with “crows feet” refer to the relationship that one element has with another, namely that the element with a straight line is the “master” of the one with the crows feet (the “slave”); one master record exists for zero or more slave records. For example a patient can have zero or more studies, and a study can have zero or more sequences.

Most information is related to the patient data 21. Patient data 21 includes patient identifying information for each patient where more than one patient's data files are stored on the device. Files relating to patient images may be broken down into study 22, sequence 23 and image 24. A patient can have any number of studies 22, each of which can have any number of sequences 23, each of which can have any number of images 24, each of which can have any number of attachments 25 such as overlays, reports, video, voice, or other attachments. Other data files 27 are associated with a patient 21. Both the image files and other data files may be associated with a particular health event 28, e.g., a disease, injury, etc. of a patient 21. Other organizational categories or breakdowns of other data files may be included in the relational database 20.

For a given patient 21, any number of records can be held denoting a combination of study 22 or health event 28. A record in the health event 28 list indicates that a particular study 22 or file 27 is related to a particular health event 28. Although the security system described herein provides access to all files with a password or biometric. Combinations of entries can provide any configuration of authorization a patient may devise using multiple levels of passwords or other identification means. These preferences are entered by the user/patient and/or Imaging Center (IC) technicians using a front-end administration tool when a study is done and downloaded onto the storage device 10 at the imaging center. The images 24 or other files 27 are loaded onto the storage device 10 to update the data files 18 and organizational or relational database 20 on the storage device 10. The user files 26 includes a list of individuals or organizations who may be authorized to review, use or add on to particular files 27 and studies 22.

In one variation of the invention, an image is converted at the imaging center's local workstation to an image file having a standard medical image format such as DICOM. Any other available image format may be used, for example, JPEG. The image file will also contain various data (“key information”) that identifies the image file, for example, patient information, study, sequence and image information or numbers, radiology center information, referring physician, radiologist, date, etc. (if it is a an image, the physician, imaging center, date, body part, study, sequence and image numbers, if it is a report, to which study etc. it belongs; if it is an annotation, to which image it belongs). Such key information is also included with any other data file 27 saved on the storage device 10. In one embodiment, the imaging center stores the image and key information identifying the image, in the relational database in the memory device 14. Other files may be attached to the image file at various stages of the image file review and exchange, e.g., at the viewing station 40 and may then be saved on the storage device 10. The viewer also has the ability to save images or attachments with key information saved in the appropriate location in the relational database 20 in the storage device 10. When the image is stored on the storage device, key information extraction logic will store the file in a filesystem and the key information in the relational database. Thus, the key information and relevant identifying information are stored in the database and are linked to the location of the stored file

In one embodiment, the data files may be downloaded to, backed-up or saved on a central database, for example by using a secured electronic transmission means. Such central database and secure packaging and transmission are described for example in co-pending U.S. patent application Ser. No. 09/871,997 incorporated herein by reference.

Once studies are transmitted to the viewing station 40 from the storage device 10, they are automatically stored in the viewer's database. Key information from the files are extracted and are placed in a local relational database so that the files may be easily viewed and/or manipulated at the viewer. Information relating to an exam may be stored such as, for example, by the referring physician, the date, the image center, the procedure, etc. Various image information may be included as well, such as size, image type, height, width, orientation, position, etc. The image files and other files are then available for viewing or other display by a user at the viewing station. Preferably a display or process is provided at the viewing station to display and access a relational structure that is based on extracted key information. The viewing station process may also provide additional functions that typically require files be located at the viewer, for example, image manipulation such as three dimensional modeling that may be used to prepare for future surgery or may aid in the diagnosis and/or treatment of a patient. Other manipulation and input functions, for example, may include the ability of the user to annotate, or mark an image and save such annotations or marks in the portable device memory and relational database.

A user at the viewing station 40 may open the files 18 downloaded and stored in the viewer database. The files are accessible through the relational database such as an Access™ database. A user input device allows a user to select files at the viewing station 40 and view the images and manipulate the images using various applications as desired. The user input device also permits creating attachments such as overlays (marks on images typically placed on images by radiologists or other physicians), voice, text video, or other attachments to the viewed files, which may be stored in the storage device 10.

When the viewing station 40 retrieves the data files 18 from the storage device 10, it parses (i.e., breaks down giving form and function to each part) the file to determine the attachment or object type (data type), e.g., image, report, overlay, or other attachment. A unique identifier or number is preferably provided for each study and image as part of the organizational, relational database and as part of the particular data file 18. If there is a report, for example, the report will be provided with the study identification number. The object is extracted from the image and installed in the database

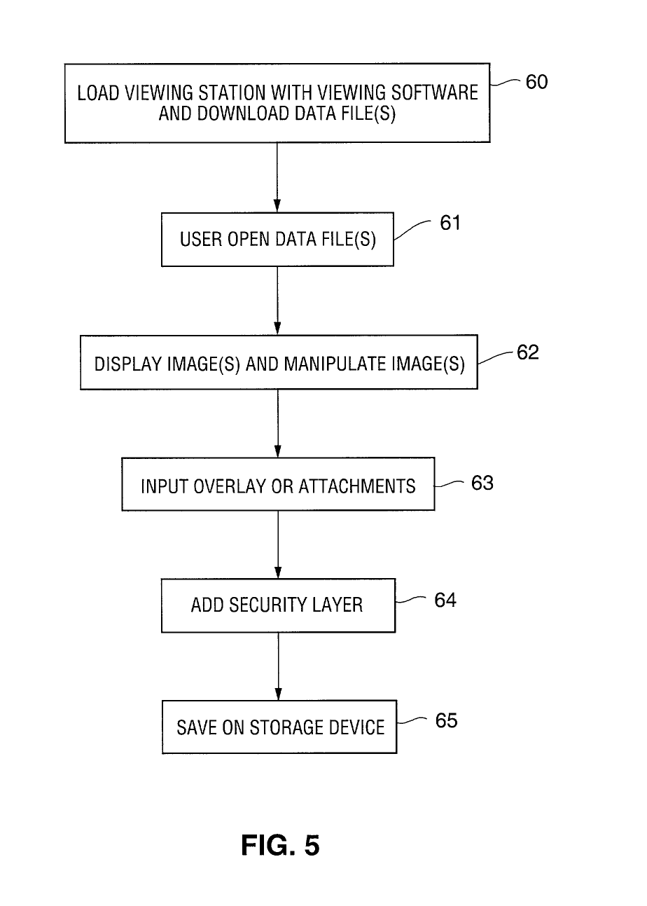

Referring to FIG. 5, there is illustrated an example of a method of the invention of updating a storage device 10. After appropriate security validation, the viewing software 17 is installed into the viewing station 40 through the storage device 10, which is plugged into a USB port 42 and recognized as a drive. (step 60) A user then selects and opens a data file (step 61) to display an image. The image is displayed and manipulated (62). An overlay and/or attachment is created (step 63). A security layer is added to the overlay or attachment if desired, restricting use of the file to input of a particular security code or biometric at a particular level of security. (step 64) The overlay or attachment is stored with key information in the storage device, with corresponding key information saved in the relational database. (step 65)

The user may create overlays on the images, for example, to point out areas of interest. The overlays may be saved for use by the patient or other healthcare providers, insurers or other users on the storage device 10. The overlay is stored on the storage device 10 and may be retrieved by an authorized user or the patient. Other attachments may be similarly saved on the device 10, for example, a radiologist or other physician may prepare a report, and voice, video or other attachments which may be saved on the device 10.

In addition to loading image files at an imaging center or adding to the data files from a viewing station, data files may be directly imported by a patient/user from a physical medium e.g. a CD-ROM drive, floppy, ZIP drive or local network drive, etc, with input of key identifying information. Other ways of importing data into the local image viewer may include scanning text reports and associating with images (a physical medium, e.g. a CD-ROM driver, floppy, ZIP drive or local network drive, etc., a scanner for scanning text or images, or the output of an imaging device, e.g., digital camera, etc.) An input allows inputting of files to be associated with a patient event 28 or a study 22. The patient/user may input key information through an input device to be associated for example with the data file 18. The key information is stored in the relational database 20.

The invention described above may take various forms or may be accomplished in a variety of manners that will accomplish the described invention and are contemplated to be within the scope of the invention as claimed herein.

What is claimed is:

1. A portable medical image storage device comprising:
a hand held housing;
a universal port connector coupled to the housing; and
a readable, writeable, memory device comprising:
a viewer comprising software configured to enable the display of a data file relating to a patient's healthcare;
an installer arranged to install the viewer to a memory of a computer when the installer is coupled with the universal port connector to a universal port of a computer that recognizes the memory device as a drive;
data file storage arranged to store a data file relating to a patient's viewer; and
a relational database arranged to store key information relating to each data file stored in the data file storage.

2. The portable medical image storage device of claim 1 wherein the hand held housing is thumb-sized.

3. The portable medical image storage device of claim 1 wherein the universal port connector is a USB connector.

4. The portable medical image storage device of claim 1 wherein said data file storage is adapted to store a data file comprising a medical image and wherein said viewer is configured to enable the display of a medical image.

5. The portable medical image storage device of claim 4 wherein said viewer is configured to enable the manipulation of a medical image.

6. The portable medical image storage device of claim 1 wherein said viewer is configured to enable saving of an additional data file to the data storage from the computer and addition of key information associated with the additional data file to the relational database.

7. The portable medical image storage device of claim 6 wherein the additional data file comprises a notation on a medical image data file stored on the portable medical image storage device and wherein the additional data file and medical image data file are associated in the relational database.

8. The portable medical image storage device of claim 1 comprising a data file selected from a group comprising: an image file; a text file; and an audio file.

9. The portable medical image storage device of claim 1 comprising a data file selected from a group comprising: a medical image; a medical provider report; a medical test result, patient monitored information, and a vital sign reading.

10. The portable medical image storage device of claim 1 wherein the key information is selected from a group comprising: patient identification information, patient health event information, data file identification information; image study information, image sequence of a study information; image information; and attachment identification information.

11. The portable medical image storage device of claim 1 wherein the memory device comprises a flash memory device.

12. A portable medical image storage device comprising:
housing means;
memory means comprising:
viewer means for enabling the display of a data file relating to a patient's healthcare;
installer means for installing the viewer means into a memory of a computer;
data file storage means for storing a data file relating to a patient's healthcare; and
relational database means for storing key information relating to each data file stored in the data file storage means; and
universal connector means for coupling the memory means to a universal port of a computer.

13. The portable medical image storage device of claim 12 wherein said data file storage means comprises medical image storage means and wherein said viewer means comprises a medical image display means.

14. The portable medical image storage device of claim 13 wherein said viewer means comprises a medical image manipulation means.

15. The portable medical image storage device of claim 12 wherein said viewer means comprises an additional file saving means for saving additional data files to the data storage means from the computer and an additional key information saving means for saving key information associated with the additional data files to the relational database means.

16. The portable medical image storage device of claim 15 wherein the additional data file storage means comprises means for storing a notation on a medical image data file stored on the portable medical image storage device so that the notation is associated with the medical image data file in said relational database means.

17. A method for adding files to a portable medical image storage device comprising the steps of:
1) providing a portable medical image storage device comprising:
a hand held housing;
a universal port connector coupled to the housing; and
a readable, writeable, memory device comprising:
a viewer comprising software configured to enable the display of a data file relating to a patient's healthcare;
an installer arranged to install the viewer to a memory of a computer when the installer is coupled with the universal port connector to a universal port of a computer that recognizes the memory device as a drive;
data file storage arranged to store a data file relating to a patient's healthcare; and
a relational database arranged to store key information relating to each data file stored in the data file storage;
2) providing a input/display device with the viewer wherein the input/display device comprises a memory;
3) loading a data file from the portable device into the memory of the input/display device; displaying the data file; inputting an additional data file and saving the additional file in the data file storage of the portable medical image storage device.

18. The method of claim 17 further comprising the step of saving key information identifying the additional file, in the relational database of the portable medical image storage device.

19. The method of claim 17 wherein the step of providing the input/display device with the viewer comprises installing the viewer from the portable medical image storage device into a memory of the input/display device.

20. The method of claim 17
wherein the step of loading a data file from the portable device into the memory of the input/display device comprises loading an image file into the memory of the input/display device; and
wherein the step of inputting an additional data file and saving the additional file in the data file storage of the portable medical image storage device comprises inputting an saving a data file comprising a comment relating to the image file.
